(19) United States
(12) Patent Application Publication
(10) Pub. No.: US 2018/0235332 A1
(43) Pub. Date: Aug. 23, 2018

(54) GOLF CART ACCESSORY

(71) Applicant: CYNWARK Corporation, The Woodlands, TX (US)

(72) Inventor: Cynthia A. Wark, The Woodlands, TX (US)

(21) Appl. No.: 15/960,699

(22) Filed: Apr. 24, 2018

Related U.S. Application Data
(63) Continuation of application No. 14/556,359, filed on Dec. 1, 2014.

(51) Int. Cl. A45C 3/00; A45C 13/02; A45F 3/02

(52) U.S. Cl. CPC A45C 3/00; A45C 13/02; B62B 2202/404; A45C 13/023; A45F 3/02

(57) ABSTRACT

A golf cart accessory in the form of a flexible woven ballistic fabric tote bag with a zippered top and a rearwardly offset strap, the attachment points of which to the tote are spaced apart by approximately the same distance as the distance between the vertical portions of a seatside-assist handle on a golf cart, whereby the strap may be looped over the golf cart seatside-assist handle to provide auxiliary storage for various items without taking up space in the passenger compartment of the golf cart. The strap is preferably adjustable in length so that the tote may also be carried on the shoulder of the user when it is not mounted on a vehicle. A small zippered case is tethered to the tote near one end of the zipper path.

### CROSS-REFERENCE TO RELATED APPLICATION

This application is a continuation of U.S. Utility patent application Ser. No. 14/556,359 filed Dec. 1, 2014, and claims the benefit thereof for common subject matter.

### FIELD OF THE INVENTION

The invention relates to golf cart accessories and more particularly to a personal tote which is especially adapted to be hung from the seatside assist handle of a conventional golf cart.

### BACKGROUND OF THE INVENTION

Golf players on both public and private courses tend to favor the use of electric and gas-powered carts to convey them and their golf equipment around the course. Since the typical 18-hole golf course often measures nearly 4 miles in length, the use of a cart conserves the golfer's energy and saves time.

Golfers may want or need more equipment during a golf round than can be conveniently located in the storage facilities associated with the typical conventional golf cart. For example, the golfer may wish to carry additional clothing to deal with weather contingencies as well as personal items such as purses, mobile telephones and the like. In addition, it is common to remove head covers during play, and they are often lost as a result of placing them in unsecure locations; e.g., they are often stuffed into crevices or into the top of the club bag.

### SUMMARY OF THE INVENTION

The present invention provides convenient and supplemental storage by providing a storage bag or “tote” that can be carried by the golfer as well as easily attached to a golf cart. The tote typically comprises a generally rectangular body of durable, water resistant material such as a woven ballistic polymer like nylon or polyester defining a bottom, opposed end panels and parallel front and rear major panels. If a top is present, it is preferably provided with a full length zipper so as to permit the top to be opened for access to the interior of the tote. This zipper closure preferably extends substantially the entire longitudinal length of the tote which, in a preferred design and size, measures approximately 16-18 inches in overall length. The tote is preferably fully lined and provided with interior and exterior pockets.

In accordance with the invention, a hanging strap is attached to the tote with two attachment points approximately 13 to 15 inches apart and at or near the top of the rear panel so that they are offset toward the cart when the strap is looped over the side-assist handle of a conventional golf cart. As a practical matter, the longitudinal dimension of such an assist handle is approximately 13 inches; approximately the same as the distance between the attachment points of the offset hanging strap, such that when the strap is looped over the side-assist handle, the bag hangs down against the side of the golf cart battery box and is relatively well-secured against fore and aft movement or swinging, as might otherwise occur during stop and start movements of the golf cart. The tote is readily accessible to the golfer and does not impede getting into or out of the cart seat. As can be seen, the invention lies in the tote itself as well as in the method of using it.

In a preferred embodiment, a flat strip of hard but flexible stiffening material such as fiberglass is sewn into the back panel adjacent the intersection of the back panel with the top and in the plane of the back panel, so as to prevent longitudinal collapse of the tote in use. In the preferred embodiment, a channel is provided in the tote such that the stiffening strip can be at least semi-permanently installed.

Also in a preferred embodiment, an optional auxiliary small zippered case is removably attached by means of a tether and clasp to the bag adjacent the starting end of the zipper closure in the top panel, such that the small auxiliary case can either be dropped into the interior of the tote by opening the zipper a bit, or removed to the outside for convenient storage of tees, change, and other small items. The auxiliary case is preferably zippered and made of the same material as the tote itself, so that the two are clearly matched to one another in a stylish fashion.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying photographs, the latter being briefly described hereinafter.

### BRIEF SUMMARY OF THE DRAWINGS

The description herein makes reference to the accompanying drawings wherein like reference numerals refer to like parts throughout the several views and wherein:

FIG. 1 shows in perspective a conventional golf cart with a tote according to the present invention attached thereto;

FIG. 2 is a perspective view of a personal golf cart tote accessory in accordance with the present invention;

FIG. 3 is another perspective view showing the rear of the personal tote of FIG. 2; and

FIG. 4 is another perspective view of the front of the tote showing how the auxiliary case can be tethered to the tote for placement both inside and outside of the tote.

### DETAILED DESCRIPTION OF THE ILLUSTRATIVE EMBODIMENT

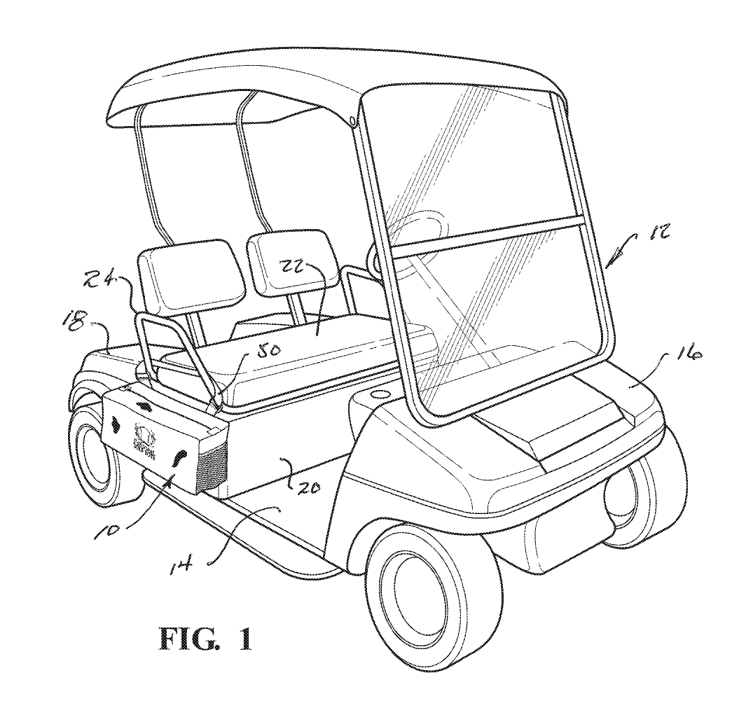

As shown in FIG. 1, a golf cart accessory in the form of a generally rectangular, flexible tote bag 10 is hung by means of a strap 50 to a side-assist handle 24 of a conventional golf cart 12 having a floor 14, a front body structure 16, and a rear body structure 18. A battery box 20 with flat, vertical sides is mounted on the floor 14 and a hinged and cushioned seat 22 is installed on top of the battery box 20. On opposite sides of the seat box 20 and the seat 22, are rigid seatside-assist handles 24 generally made of steel or plastic tubing and extending upwardly along the sides of the seat 22 by approximately 10-14 inches. The top of the assist handle 24 is shorter in horizontal dimension than the bottom to provide on and off access to the cart seating area. The bottom of the handle merges into the seat box so as to provide a stop for the tote strap 50 when looped over the handle 24; i.e., the tote 10 hung by way of the strap 50 is effectively captured by the handle 24 and will not fall away significantly below the seat plane. The tote may be lifted off of the handle 24 by the user. As a practical matter, the length of the handle at the bottom where it attaches to the seat/battery box is approximately 12-14 inches on a conventional cart. The terms “seat box” and “battery box” are used interchangeably herein.

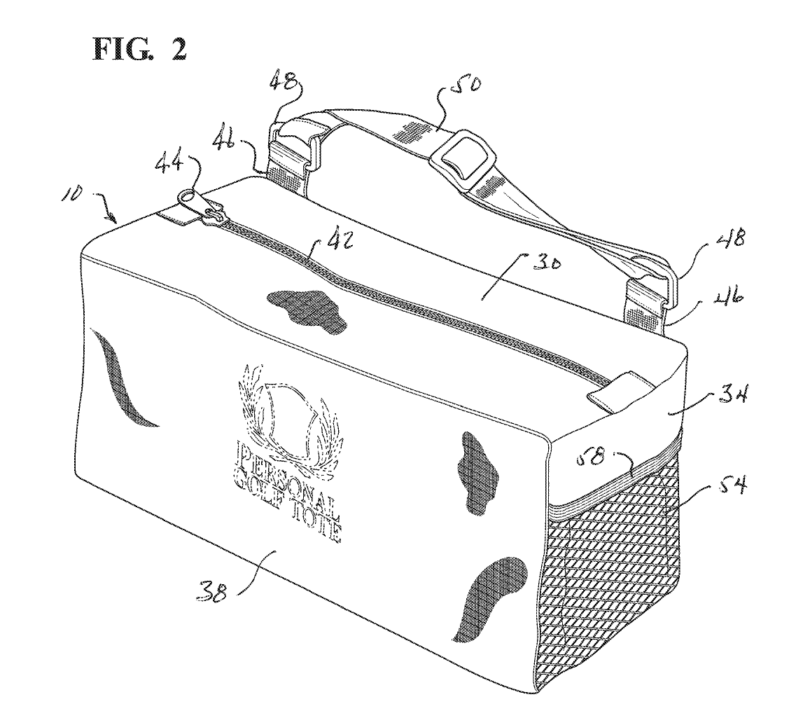

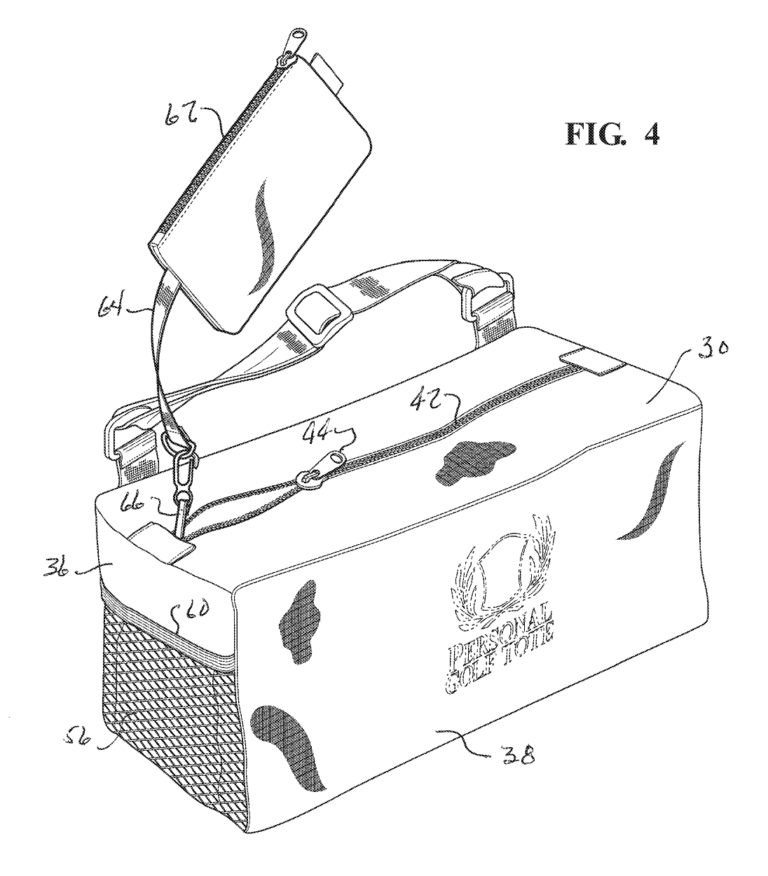

Referring now to FIGS. 2 through 4, the tote 10 is shown to comprise a generally rectangular body of woven ballistic polymeric material which is both durable and waterproof, as well as flexible unless stiffened by one or more auxiliary panels, as hereinafter described. The tote 10 comprises a generally rectangular top 30, a generally rectangular bottom which may be reinforced by a stiffening panel 32, end panels 34, 36 and generally rectangular front and rear panels 38, 40, respectively. The main panels are preferably sewn together at welted intersections to define a closed body. Panel 32 may be loose. The interior may be lined or unlined, as desired. A lining adds to moisture tolerance and provides interior pockets (not shown).

As shown in the figures, the top panel 30 is bifurcated by means of a zipper closure 42 having a pull 44. The zipper closure 42 runs essentially the entire longitudinal length of the top panel 30 between the end panels 34, 36. While it is shown precisely in the fore and aft center of the tote 10, it may also be offset either toward the front or the rear; the preference, however, is to locate the zipper closure 42 essentially centrally of the top panel 30.

Sewn into the tote at or near the opposite ends thereof are flexible fabric tabs 46 which receive closed plastic loops 48 which serve as attachment points or couplers for the adjustable hanging strap 50. The distance between the centers of the attachment point tabs 46 is approximately 14 inches so as to permit the strap 50 to be looped over the seatside-assist handle 24 of the golf cart 12 as shown in FIG. 1. The strap 50 is made adjustable so that the tote 10 can not only be attached to the golf cart when shortened, but carried conveniently over the shoulder of the user when made longer. Net compartments 54, 56 may be attached to the side panels as shown in the figures with elastic top trim 58, 60 respectively, so as to permit the insertion and convenient carrying of items such as golf balls or mobile telephones.

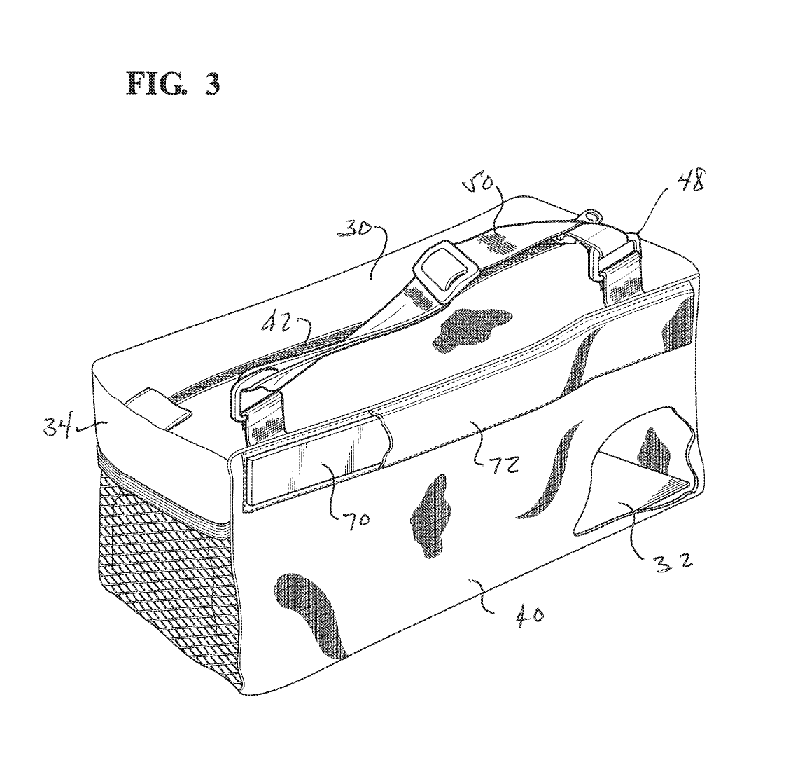

As shown in FIG. 3, a flat strip 70 of hard, but flexible stiffening material, approximately 1½ inches in width and 16 inches in length may be sewn or otherwise trapped into and between layers of the back panel 40 and extending substantially fully between the opposite end panels of the tote so as to prevent longitudinal collapse of the tote when it is not filled to capacity by personal articles, such as clothing. The strip 70 is located parallel to and adjacent to the welted intersection between the rear panel 40 and the top panel 30 so that it lies against the side of the seat 22 as shown in FIG. 1 when the bag is properly installed on the seatside-assist handle 24. Because the tote lies flat against the vertical side of the box 20, it is not in the way of a golfer, yet is conveniently accessed during a round.

As an option, a short clip 66 is permanently attached to the tote adjacent the starting end of the zipper closure 42. The clip receives a tether 64 of a small auxiliary zippered case 62, which can be provided for carrying small items such as golf tees and change. The location of the clip 66 is such that the small zippered case 62 can be easily inserted into the interior of the bag and the zippered closure 42 substantially fully closed or, in the alternative, the case 62 may be removed to the outside of the tote 10 for access. The case 62 is preferably made of the same material and in the same color as the tote 10 so that the tote 10 and the auxiliary case 62 are clearly and stylishly associated with one another.

In use, the tote 10 is at least partially filled with items the golfer chooses and the strap 50 is lengthened to permit carrying on the shoulder. The tote is carried to the cart 12 and the strap 50 adjusted to a shorter length. The shortened strap is then looped around and over the top exposed portion of the seatside-assist handle 24. This allows the tote 10 to hang downwardly with the flat, stiffened back panel against the side of the battery box 20 where it is out of the way of players entering and exiting from the cart 12, yet providing convenient access to the player either on the seat or standing alongside of the cart. The tote 10 takes up no interior room in the cart and does not otherwise burden the storage areas and/or cup holders that are built into a conventional golf cart. Additional items may be placed in the tote during travel with the cart; it may also provide a convenient place for refuse.

In the preferred embodiment, the length of the tote 10 is approximately 16-18 inches, the depth is approximately 5 inches, and the height is approximately 8 inches. The distance between the tabs 46 is 14 inches. The front panel 38 can be embroidered or otherwise provided with a decorative image or logo, as shown in FIGS. 1, 2, and 4.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures and methods of use as is permitted under the law.

1. A method of providing removeable supplemental storage in association with a golf cart having a seat structure with an outside vertical surface and an inverted U-shaped seatside assist handle attached to the top of the seat structure at two horizontally spaced anchor points by attaching to said handle a tote bag made of flexible material and having side panels and parallel front and rear planar panels and a flexible hanging strap attached to the tote bag adjacent the top of the rear panel at two laterally spaced attachment points the distance between which is between about 13″ and 15″ and corresponds generally to the spacing between said handle anchor points, the tote bag having installed in the rear panel adjacent the top thereof a stiffening strip to maintain the shape of the tote bag in use, the method comprising the steps of:
a. hanging the tote bag on the handle by looping said strap over and around said handle outside of said anchor points such that the tote bag back panel lays flush against the seat structure vertical surface immediately below said U-shaped handle;
b. storing articles in the container during use of the golf cart; and
c. removing the tote bag from the golf cart after use thereof.

2. The method defined in claim 1, wherein the tote bag material is a water resistant woven material.

3. The method of claim 2, wherein the material is chosen from the group consisting of Nylon and Polyester.

4. The method of claim 1, wherein the tote bag includes a waterproof lining.

5. The method defined in claim 1 wherein the strap is adjustable between a short length that, when looped over said element essentially corresponds to the length between said attachment points thereby to inhibit swinging of the container relative to the vehicle during movement of the vehicle, and a longer length suitable for shoulder carrying by a human user.

6. The method defined in claim 1 wherein the tote bag has a top panel secured between said front and rear panels and containing a zipper running the full length of said top panel between the side panels of said container for access.

7. (canceled)

8. (canceled)

9. (canceled)

10. A tote bag adapted for both shoulder strap carrying and mounting on the seatside assist handle of a motor driven golf cart comprising:
a tote bag body made of a flexible polymeric material having parallel front and rear panels, parallel side panels and bottom panel and a top panel, said top panel having a full length, center mounted zipper extending between the ends thereof for access to the interior of the tote bag;
an adjustable strap attached to the top panel immediately adjacent the top of the rear panel at attachment points which are spaced apart by approximately 13″ to 15″, said strap being adjustable in length between a long length being suitable for shoulder carry and a short length of approximately 15″;
said rear panel having fitted into a portion of the top thereof immediately adjacent the top panel a hard but flexible stiffening strip extending the full distance between said attachment points to stiffen and maintain the shape of the tote bag in use;
whereby the tote bag may be carried to a golf cart, the strap shortened to the shorter length and the strap hung on and around the seatside assist handle of a golf cart so as to hang vertically downwardly therefrom and against the face of a golf cart seat box during use of the golf cart.
